(19) United States
(12) Patent Application Publication
(10) Pub. No.: US 2015/0092270 A1
(43) Pub. Date: Apr. 2, 2015

(54) Optical Imaging Lens

(71) Applicant: Genius Electronic Optical Co. Ltd., Taichung City (TW)

(72) Inventors: Hui-Man Wang, Taichung City (TW); Chien-Jui Lin, Taichung City (TW); Chun-Lin Yeh, Taichung City (TW)

(73) Assignee: Genius Electronic Optical Co. Ltd., Taichung City (TW)

(21) Appl. No.: 14/197,622

(22) Filed: Mar. 5, 2014

(30) Foreign Application Priority Data
Sep. 30, 2013 (TW) 102135347

(51) Int. Cl. G02B 7/02

(52) U.S. Cl. CPC G02B 7/021; G02B 7/026
USPC 359/503

(57) ABSTRACT

An optical imaging lens includes a lens barrel, a front lens element, plural intermediate lens elements, and a rear lens element. The front lens element has a first central lens portion and a first assembly portion. The first assembly portion has a first front abutting section, a first front slanting surface section, and a first rear slanting surface section. Each of the intermediate lens elements has a second central lens portion and a second assembly portion. The second assembly portion has a second front slanting surface section and a second rear slanting surface section. The rear lens element has a third central lens portion and a third assembly portion. The third assembly portion has a third front slanting surface section.

### CROSS-REFERENCE TO RELATED APPLICATION

This application claims priority of Taiwanese application no. 102135347, filed on Sep. 30, 2013.

### BACKGROUND OF THE INVENTION

1. Field of the Invention

The present invention relates to an optical imaging lens.

2. Description of the Related Art

Japanese patent No. JP3739295 (hereinafter referred to as JP295) discloses an optical imaging lens assembly. The optical imaging lens assembly includes a lens barrel and a plurality of optical lenses disposed within the lens barrel. When assembling the optical imaging lens assembly, an object side of a first optical lens adjacent to a front end of the lens barrel has a vertical surface perpendicular to an optical axis of the lens barrel and abutting against the front end of the lens barrel, and an image side of the first optical lens has a conical abutting surface. An object side and an image side of each of the rest of the optical lenses has a conical abutting surface. The conical abutting surfaces slant towards the optical axis and the object side. When assembling the optical imaging lens assembly, adjacent ones of the optical lenses are coupled to each other only by the conical abutting surfaces thereof without involving any other surface, and are secured together using an adhesive. Furthermore, the periphery of each of the optical lenses does not contact an inner wall surface of the lens barrel, leaving a space therebetween. The adhesive may flow into the spaces, and the solidified adhesive may cause the optical lenses to deform due to thermal contraction and expansion, which may degrade image quality. Apart from the first optical lens, each of the rest of the optical lenses is coupled to the optical lens immediately in front, and the vertical surface of the first optical lens abuts against the front end of the lens barrel. Therefore, the optical lenses are only secured in the direction of the optical axis and not in the radial directions, which may cause shifting of images detected by a charged-coupled device (CCD) that is mounted to the lens barrel.

Taiwan Patent Publication No. 201202779 (hereinafter referred to as TW779) discloses another optical imaging lens assembly. The optical imaging lens assembly mainly includes a lens barrel and a plurality of optical lenses disposed within the lens barrel. An object side of a first optical lens adjacent to a front end of the lens barrel has a conical abutting surface that slants towards the optical axis and the object side and that abuts against the front end of the lens barrel. Similarly, each of the optical lenses behind the first optical lens is coupled in the same manner with the optical lens immediately in front. This enables the optical lenses to be secured in both the axial and radial directions in the lens barrel. The lens barrel and the optical lenses are usually made of plastic material and thus possess a certain amount of elasticity. If an aperture is designed to be proximate to the first optical lens, variation of pressure applied to the optical lenses during assembly may arise in difficulty in controlling the relative position between the aperture and the first optical imaging lens, and thus the manufacturing quality of the optical lens assemblies. Moreover, the conical abutting surfaces formed on the object sides of the optical lenses increase complexity in the design of the lens barrel when taking into account the problem of angles of the light rays entering from the front end of the lens barrel, not to mention a high precision required in the manufacturing of such design.

In summary, the assembly precision of an optical imaging lens assembly is affected by the manufacturing precision of both the peripheries of the optical lenses and the lens barrel. Although the techniques applied in JP295 may lower the impact of the manufacturing precision of the lens barrel on the assembly precision of the optical imaging lens assembly, the application of the vertical surface of the first optical lens abutting against the front end of the lens barrel does not secure the first optical lens in the radial directions. Moreover, the application of an adhesive for fixing optical lenses to the lens barrel would not pose a problem in an optical imaging lens assembly in which the optical lenses abut tightly against an inner wall surface of the lens barrel. However, in JP295, spaces are formed between the optical lenses and the lens barrel, and the adhesive may easily enter into the spaces and cause deformation of the optical lenses due to thermal contraction and expansion later on. Although the problem of the vertical surface of the first optical lens abutting against the front end of the lens barrel being unable to secure the optical lenses in the radial directions can be overcome by the design of the optical imaging lens assembly in TW779, the variation of the pressure applied to the optical lenses during assembly will affect the distance between the aperture and the first optical lens, and may arise in difficulty in controlling the relative position between the aperture and the first optical lens. Moreover, the conical abutting surface formed on the lens barrel increases complexity in the design of the optical imaging lens assembly, and thus may affect the overall assembly precision of the optical imaging lens assembly.

### SUMMARY OF THE INVENTION

Therefore, the object of the present invention is to provide an optical imaging lens that may promote assembly precision and that may secure lens elements in both axial and radial positions within a lens barrel.

According to the present invention, an optical imaging lens comprises:

a lens barrel including a surrounding wall and a front wall connected to one end of the surrounding wall, the front wall having an abutting portion, and a first slanting surface portion connected to the abutting portion; and

an imaging lens unit disposed in the lens barrel and including a front lens element, a plurality of intermediate lens elements and a rear lens element arranged in an order from an object side to an image side, each of the front lens element, the intermediate lens elements and the rear lens element having an object side surface facing toward the object side and an image side surface facing toward the image side;

The front lens element has a first central lens portion and a first assembly portion surrounding the first central lens portion. The first assembly portion has a first front abutting section and a first front slanting surface section disposed at the object side surface of the front lens element, and a first rear slanting surface section disposed at the image side surface of the front lens element.

Each of the intermediate lens elements has a second central lens portion and a second assembly portion surrounding the second central lens portion. The second assembly portion of each of the intermediate lens elements has a second front slanting surface section disposed at the object side surface thereof, and a second rear slanting surface section disposed at the image side surface thereof.

The rear lens element has a third central lens portion and a third assembly portion surrounding the third central lens portion. The third assembly portion has a third front slanting surface section disposed at the object side surface of the rear lens element.

The first front abutting section and the first front slanting surface section of the first assembly portion abut against the abutting portion and the first slanting surface portion of the front wall respectively, such that the first assembly portion is coupled with the front wall.

The second front slanting surface section of the second assembly portion of a frontmost one of the intermediate lens elements abuts against the first rear slanting surface section of the first assembly portion, such that the second assembly portion of the frontmost one of the intermediate lens elements is coupled with the front lens element.

The second front slanting surface section of the second assembly portion of a rear one of the intermediate lens elements abuts against the second rear slanting surface section of the second assembly portion of one of the intermediate lens elements that is immediately in front of the rear one of the intermediate lens elements to thereby couple the second assembly portions of the intermediate lens elements to each other.

The third front slanting surface section of the third assembly portion abuts against the second rear slanting surface section of the second assembly portion of a rearmost one of the intermediate lens elements that is immediately in front of the rear lens element, such that the second assembly portion of the rearmost one of the intermediate lens elements is coupled with the rear lens element.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary cross-sectional view illustrating an optical imaging lens of a first preferred embodiment of the present invention;

FIG. 2 is a fragmentary cross-sectional view to illustrate maximum distances between slanting surface sections of lens elements and an optical axis of the optical imaging lens;

FIG. 3 is a fragmentary cross-sectional view illustrating the optical imaging lens of a second preferred embodiment of the present invention;

FIG. 4 is a fragmentary cross-sectional view illustrating the optical imaging lens of a third preferred embodiment of the present invention;

FIG. 5 is a fragmentary cross-sectional view illustrating the optical imaging lens of a fourth preferred embodiment of the present invention; and

FIG. 6 is a fragmentary cross-sectional view illustrating the optical imaging lens of a fifth preferred embodiment of the present invention.

### DETAILED DESCRIPTION OF THE PREFERRED EMBODIMENTS

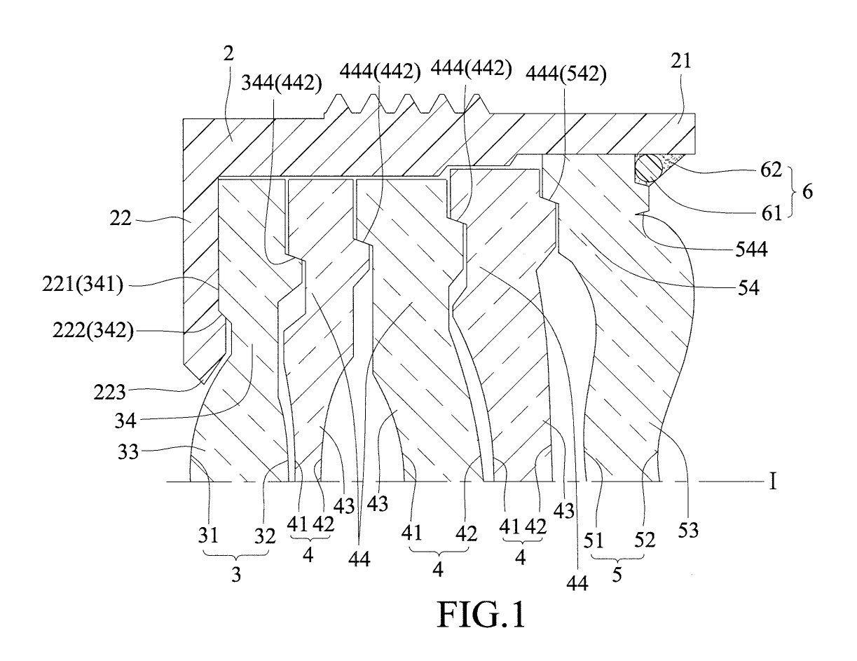

Referring to FIG. 1, the first preferred embodiment of an optical imaging lens according to the present invention includes a lens barrel 2, an imaging lens unit 10, and a fixing unit 6. The imaging lens unit 10 includes a front lens element 3, a plurality of intermediate lens elements 4 and a rear lens element 5 arranged in an order from an object side to an image side. Each of the front lens element 3, the intermediate lens elements 4 and the rear lens element 5 has an object side surface 31, 41, 51 facing toward the object side and an image side surface 32, 42, 52 facing toward the image side.

The lens barrel 2 includes a surrounding wall 21 and a front wall 22 connected to one end of the surrounding wall 2. The front wall 22 has an abutting portion 221, a first slanting surface portion 222 connected to the abutting portion 221, and a light blocking portion 223 connected to the first slanting surface portion 222. The first slanting surface portion 222 is disposed between the abutting portion 221 and the light blocking portion 223, and the light blocking portion 223 is disposed closer to an optical axis of the optical imaging lens compared to the abutting portion 221.

The front lens element 3 has a first central lens portion 33 and a first assembly portion 34 surrounding the first central lens portion 33. The first assembly portion 34 has a first front abutting section 341, and a first front slanting surface section 342 disposed at the object side surface of the front lens element 3, and a first rear slanting surface section 344 disposed at the image side surface of the front lens element 3. The first front slanting surface section 342 is disposed between the first central lens portion 33 and the first front abutting section 341. The first central lens portion 33 is an area which image light can pass through and, in this embodiment, is an area having an optical effective diameter. The first assembly portion 34 is a portion of the front lens element 3 that is outside the optical effective diameter. In other embodiments, the first assembly portion 34 may be defined as a portion of the front lens element 3 that is configured to make contact with other elements in the optical imaging lens, and the rest of the front lens element 3 may be defined to be the first central lens portion 33. The present invention is not limited to the disclosure of this embodiment.

Each of the intermediate lens elements 4 has a second central lens portion 43 and a second assembly portion 44 surrounding the second central lens portion 43. The second assembly portion 44 of each of the intermediate lens elements 4 has a second front slanting surface section 442 disposed at the object side 41 surface thereof, and a second rear slanting surface section 444 disposed at the image side surface 42 thereof. The second central lens portion 43 is an area which image light can pass through and, in this embodiment, is an area having an optical effective diameter. The second assembly portion 44 is a portion of the intermediate lens element 4 that is outside the optical effective diameter. In other embodiments, the second assembly portion 44 may be defined as a portion of the intermediate lens element 4 that is configured to make contact with other elements in the optical imaging lens, and the rest of the intermediate lens element 4 may be defined to be the second central lens portion 43. The present invention is not limited to the disclosure of this embodiment.

The rear lens element 5 has a third central lens portion 53 and a third assembly portion 54 surrounding the third central lens portion 53. The third assembly portion 54 has a third front slanting surface section 542 disposed at the object side surface 51 of the rear lens element 5. The third central lens portion 53 is an area which image light can pass through and, in this embodiment, is an area having an optical effective diameter. The third assembly portion 54 is a portion of the rear lens element 5 that is outside the optical effective diameter. In other embodiments, the third assembly portion 54 may be defined as a portion of the rear lens element 5 that is configured to make contact with other elements in the optical imaging lens, and the rest of the rear lens element 5 may be defined to be the third central lens portion 53. The present invention is not limited to the disclosure of this embodiment. The rear lens element 5 further has a protruding portion 544 disposed between the third central lens portion 53 and a peripheral surface of the rear lens element 5 at the image side surface 52 of the rear lens element 5.

The fixing unit 6 includes a ring body 61 disposed abuttingly between the image side surface 52 of the rear lens element 5 and an inner wall surface of the surrounding wall 21, and an adhesive 62 connecting the ring body 61 and the inner wall surface of the surrounding wall 21. In other embodiments where there is no space between the rear lens element 5 and the surrounding wall 21 of the lens barrel 2, the ring body 61 may be omitted. The fixing unit 6 may also be a thermoplastic material component that is hot pressed to secure the front lens element 3, the intermediate lens elements 4 and the rear lens element 5 in the lens barrel 2.

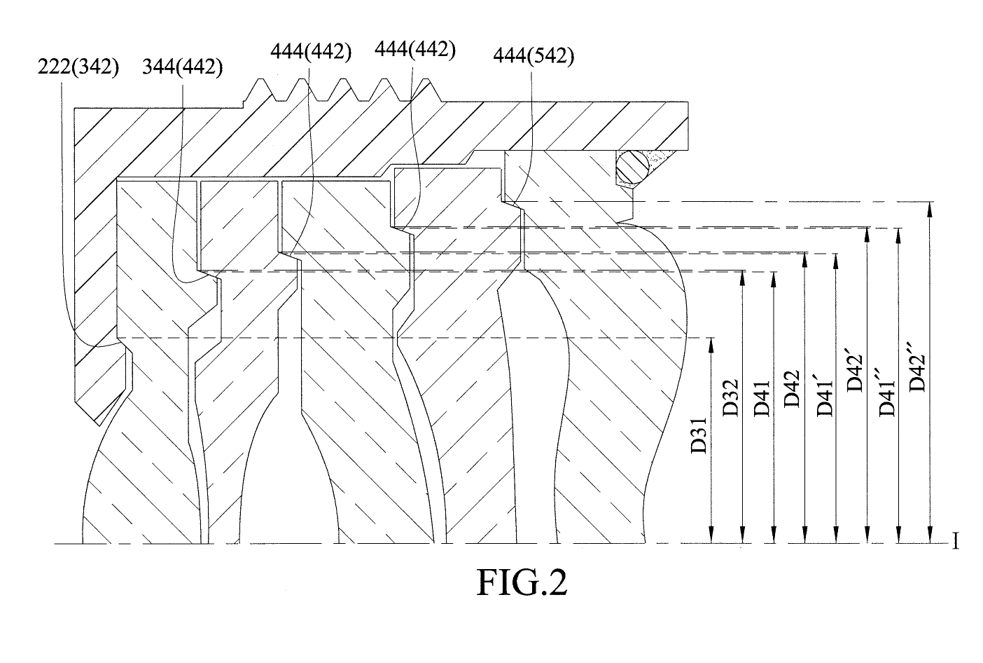

The first front slanting surface section 342 has a maximum perpendicular distance to an optical axis (I) of the optical imaging lens that is smaller than a maximum perpendicular distance of the first rear slanting surface section 344 to the optical axis, and for each of the intermediate lens elements, the second front slanting surface section 442 thereof has a maximum perpendicular distance to the optical axis (I) that is smaller than a maximum perpendicular distance of the second rear slanting surface section 444 thereof to the optical axis, i.e., D31<D32, D41<D42, D41′<D42′, D41″<D42″(see in FIG. 2). Each of the abutting portion 221 and the first front abutting section 341 is an annular planar surface that is transverse to the optical axis (I) of the optical imaging lens. The front lens element 3, the intermediate lens elements 4 and the rear lens element 5 are assembled in an order from the object side to the image side. The distances of the first front slanting surface section 342, the first rear slanting surface section 344, the second front slanting surface sections 442, the second rear slanting surface sections 444, and the third front slanting surface section 542 relative to the optical axis gradually increase, forming a mechanical structure similar to that of an arch bridge that is highly stable. In another embodiment, in which the front lens element 3 is a wide angle lens, the distances of the first front slanting surface section 342, the first rear slanting surface section 344, the second front slanting surface sections 442, the second rear slanting surface sections 444, and the third front slanting surface section 542 relative to the optical axis may gradually decrease.

The first front abutting section 341 and the first front slanting surface section 342 of the first assembly portion 34 abut against the abutting portion 221 and the first slanting surface portion 222 of the front wall 22 respectively, such that the first assembly portion 34 is coupled with the front wall 22. Preferably, there is a clearance formed between the periphery of the front lens element 3 and the inner wall surface of the surrounding wall 21. The second front slanting surface section 442 of the second assembly portion 44 of a frontmost one of the intermediate lens elements 4 abuts against the first rear slanting surface section 344 of the first assembly portion 3, such that the second assembly portion 44 of the frontmost one of the intermediate lens elements 4 is coupled with the front lens element 3. The second front slanting surface section 442 of the second assembly portion 44 of a rear one of the intermediate lens elements 4 abuts against the second rear slanting surface section 444 of the second assembly portion 44 of one of the intermediate lens elements 4 that is immediately in front of the rear one of the intermediate lens elements 4 to thereby couple the second assembly portions 44 of the intermediate lens elements 4 to each other. Similarly, a clearance is preferred to be formed between the periphery of each intermediate lens element 4 and the inner wall surface of the surrounding wall 21. The third front slanting surface section 542 of the third assembly portion 54 abuts against the second rear slanting surface section 444 of the second assembly portion 44 of a rearmost one of the intermediate lens elements 4 that is immediately in front of the rear lens element 5, such that the second assembly portion 44 of the rearmost one of the intermediate lens elements is coupled with the rear lens element 5. In this embodiment, the periphery of the rear lens element 5 abuts against the inner wall surface of the surrounding wall 21. The ring body 61 of the fixing unit 6 is disposed abuttingly between the image side surface 52 of the rear lens element 5 and the inner wall surface of the surrounding wall 21. The adhesive 62 is applied to connect the ring body 61, the rear lens element 5 and the inner wall surface of the surrounding wall 21, thus fixing the rear lens element 5 and the ring body 61 in the lens barrel 2.

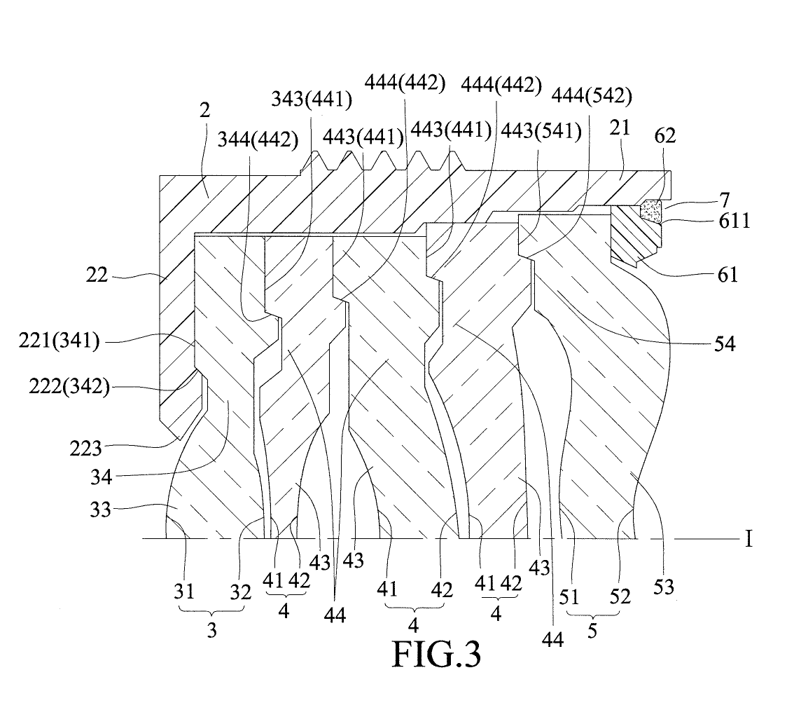

Referring to FIG. 3, a second preferred embodiment of the present invention is shown to be similar to the first preferred embodiment. In the second preferred embodiment, the first assembly portion 34 of the front lens element 3 further has a first rear abutting section 343 disposed at the image side surface 32 of the front lens element 3. The first rear slanting surface section 344 is disposed between the first central lens portion 33 and the first rear abutting section 343. The second assembly portion 44 of each of the intermediate lens elements 4 further has a second front abutting section 441 disposed at the object side surface 41 thereof, and a second rear abutting section 443 disposed at the image side surface 42 thereof. For each of the intermediate lens elements 4, each of the second front slanting surface section 442 and the second rear slanting surface section 444 is disposed between the second central lens portion 43 and a respective one of the second front abutting section 441 and the second rear abutting section 443. The periphery of one of the intermediate lens elements 4 abuts against the inner wall surface of the surrounding wall 21 of the lens barrel 2. The third assembly portion 54 of the rear lens element 5 further has a third front abutting section 541 disposed at the object side surface 51 of the rear lens element 5. The third front slanting surface section 542 is disposed between the third front abutting section 541 and the third central lens portion 53. Preferably, a space is formed between the periphery of the rear lens element 5 and the inner wall surface of the surrounding wall 21. The fixing unit 6 includes a ring body 61 disposed abuttingly between the image side surface 52 of the rear lens element 5 and the inner wall surface of the surrounding wall 21, and an adhesive 62. The ring body 61 has an annular indentation 611 adjacent to the inner wall surface of the surrounding wall 21. The annular indentation 611 and the inner wall surface of the surrounding wall 21 cooperate to de fine an annular groove 7. The adhesive 62 is filled in the annular groove 7 and connects the ring body 61 and the inner wall surface of the surrounding wall 21, thus fixing the ring body 61 to the surrounding wall 21 of the lens barrel 2.

By the abutment between the first rear abutting section 343, the second front abutting sections 441, the second rear abutting sections 443 and the third front abutting section 541, the front lens element 3, the intermediate lens elements 4 and the rear lens element 5 can be more precisely assembled to provide better structural stability.

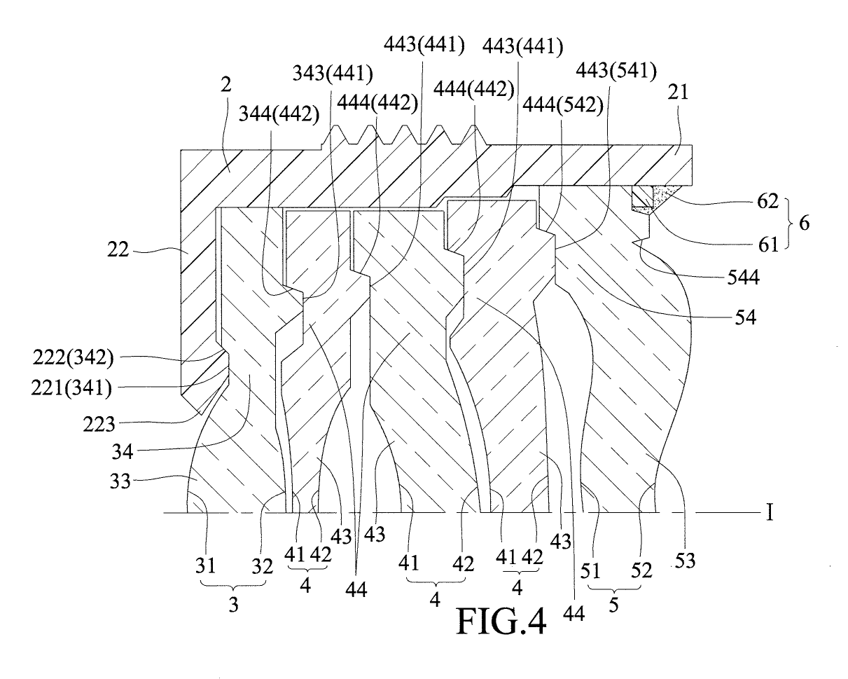

Referring to FIG. 4, a third preferred embodiment of the present invention is shown to be similar to the first preferred embodiment. In the third preferred embodiment, the front wall 22 further has a light blocking portion 223 connected to the abutting portion 221, the abutting portion 221 is disposed between the first slanting surface portion 222 and the light blocking portion 223, and the light blocking portion 223 is disposed closer to the optical axis (I) of the optical imaging lens compared to the first slanting surface portion 222. The first assembly portion 34 further has a first rear abutting section 343 disposed at the image side surface 32 of the front lens element 3. The first rear abutting section 343 is disposed between the first central lens portion 33 and the first rear slanting surface section 344. The second assembly portion 44 of each of the intermediate lens 4 elements further has a second front abutting section 441 disposed at the object side surface 41 thereof, and a second rear abutting section 443 disposed at the image side surface 42 thereof. For each of the intermediate lens elements 4, each of the second front abutting section 441 and the second rear abutting section 443 is disposed between the second central lens portion 43 and a respective one of the second front slanting surface section 442 and the second rear slanting surface section 444. The third front abutting section 541 is disposed between the third central lens portion 53 and the third front slanting surface section 542. Each of the first front abutting section 341, the second front abutting sections 441, the second rear abutting sections 443, and the third front abutting section 541 is the annular planar surface that is transverse to an optical axis (I) of the optical imaging lens.

By the abutment between the first rear abutting section 343, the second front abutting sections 441, the second rear abutting sections 443 and the third front abutting section 541, the front lens element 3, the intermediate lens elements 4 and the rear lens element 5 can be more precisely assembled to provide better structural stability.

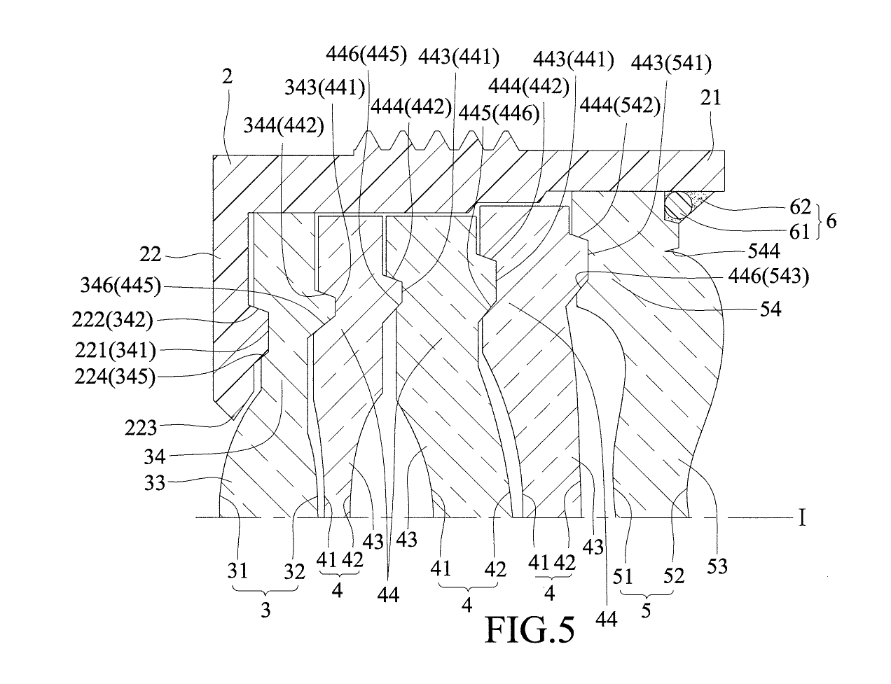

Referring to FIG. 5, a fourth preferred embodiment of the present invention is shown to be similar to the third preferred embodiment. In the fourth preferred embodiment, the front wall 22 of the lens barrel 2 further has a second slanting surface portion 224 radially spaced apart from the first slanting surface portion 222. The first assembly portion 34 further has a fourth front slanting surface section 345 radially spaced apart from the first front slanting surface section 342 and disposed at the object side surface 31 of the front lens element 3, and a fourth rear slanting surface section 346 radially spaced apart from the first rear slanting surface section 344 and disposed at the image side surface 32 of the front lens element 3. The second assembly portion 44 of each of the intermediate lens 4 elements further has a fifth front slanting surface section 445 radially spaced apart from the second front slanting surface section 442 and disposed at the object side surface 41 thereof, and a fifth rear slanting surface section 446 radially spaced apart from the second rear slanting surface section 444 and disposed at the image side surface 42 thereof. The third assembly port ion 54 further has a sixth front slanting surface section 543 radially spaced apart from the third front slanting surface section 542 and disposed at the object side surface 51 of the rear lens element 5.

By the abutment between the second slanting surface portion 224, the fourth front slanting surface section 345, the fifth front slanting surface sections 445, the fourth rear slanting surface section 346, the fifth rear slanting surface sections 446, and the sixth front slanting surface section 543, the front lens element 3, the intermediate lens elements 4 and the rear lens element 5 can be more precisely assembled to provide better structural stability.

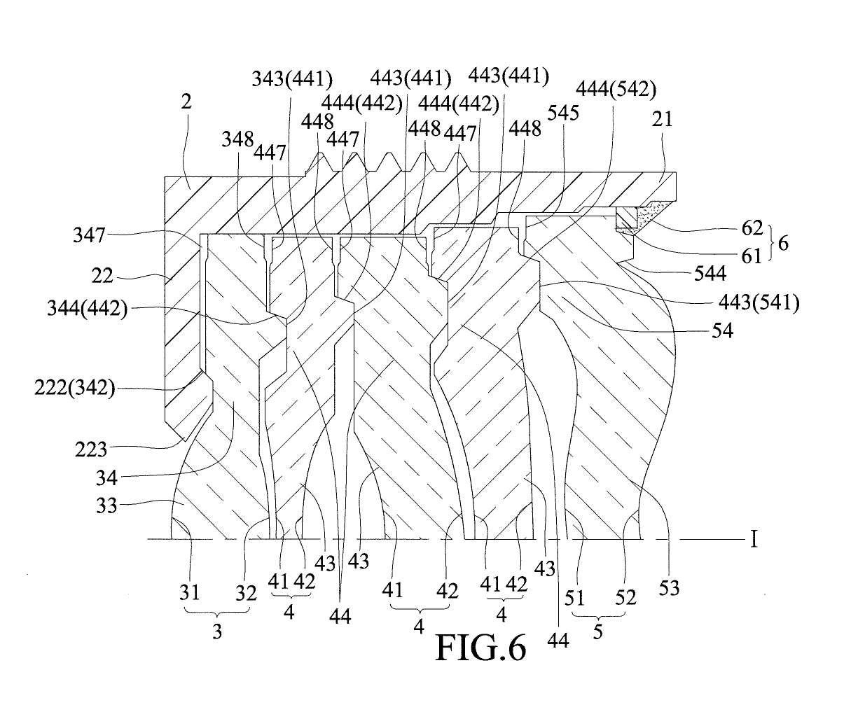

Referring to FIG. 6, a fifth preferred embodiment of the present invention is shown to be similar to the third preferred embodiment. In the fifth preferred embodiment, each of the front lens element 3 and the intermediate lens elements 4 has a rear recess portion 348, 448 at the image side surface 32, 42 adjacent to a peripheral surface thereof, and a front recess portion 347, 447, at the object side surface 31, 41 adjacent to the peripheral surface thereof. The rear lens element 5 has a front recess portion 545 at the object side surface 51 adjacent to a peripheral surface thereof.

Since burrs produced during injection molding of the lens elements may affect closeness between two adjacent lens elements and thus the assembly precis ion, the spaces formed between the rear recess portions 348, 448 and the front recess portions 347, 447, 545 can accommodate the burrs to improve assembly precision.

The effects and advantages of the aforementioned five preferred embodiments can be summarized as follows:
1. When assembling the optical imaging lens, the first front abutting section 341 and the first front slanting surface section 342 of the first assembly portion 34 abut against the abutting portion 221 and the first slanting surface portion 222 of the front wall 22 respectively, such that the first assembly portion 34 is coupled with the front wall 22. Without having the front lens element 3 sliding into different depths of the front wall 22, the relative positions between an aperture (not shown) and the front lens element 3 may be stabilized.
2. The abutting portion 221 and the first slanting surface portion 222 of the front wall 22 have simple structures that enable them to be manufactured with high precision by injection molding. The light blocking portion 223 enables desired angles of light rays to enter and pass through the front lens element 3, the intermediate lens elements 4 and the rear lens element 5 inside the lens barrel 2. These features may improve image quality and reduce the complexity for a higher manufacturing precision.
3. After using the ring body 61 of the fixing unit 6 to initially fix positions of the front lens element 3, the intermediate lens elements 4 and the rear lens element 5 and to block the gap between the periphery of the rear lens element 5 and the inner wall surface of the surrounding wall 21, the adhesive 62 is applied to secure the ring body 61, the assembly portion 54, and the inner wall surface of the surrounding wall 21. Although the peripheries of some of the front lens element 3, the intermediate lens elements 4 and the rear lens element 5 may not contact the inner wall surface of the surrounding wall 21, the ring body 61 and the adhesive 62 cooperate with the rear lens element 5 to fix the lens elements 3, 4, 5 in the radial directions, as well as in the axial direction. As the gap is blocked by the ring body 61, the adhesive 62 is prevented from flowing into the gap and causing the lens elements 3, 4, 5 to deform when the adhesive 62 thermally contracts or expands.
4. The rear lens element 5 has the protruding portion 544 at the image side surface 52 of the rear lens element 5, and the fixing unit 6 can be disposed at one side of the protruding portion 544 that is radially opposite to the optical axis (I) of the optical imaging lens. This allows the lens barrel 2 to stably accommodate the fixing unit 6 without being extended in length, thus minimizing the dimensions of the optical imaging lens. Furthermore, the protruding portion 544 prevents the adhesive 62 from flowing to the third central lens portion 53 of the rear lens element 5.
5. The maximum perpendicular distances of the first front slanting surface section 342, the first rear slanting surface section 344, the second front slanting surface sections 442, the second rear slanting surface section 444, and the third front slanting surface section 542 relative to the optical axis gradually increase, forming a mechanical structure similar to that of an arch bridge that is highly stable. Furthermore, the periphery of the rear lens element 5 abuts against the inner wall surface of the surrounding wall 21 to further stabilize the front lens element 3, the intermediate lens elements 4 and the rear lens element 5 in their respective positions in the lens barrel 2. When the front lens element 3 is a wide angle lens, the distances of the first front slanting surface section 342, the first rear slanting surface section 344, the second front slanting surface sections 442, the second rear slanting surface sections 444, and the third front slanting surface section 542 relative to the optical axis may be gradually decreased to form the arch bridge-like structure.
6. The spaces formed between the rear recess portions 348, 448 and the front recess portions 347, 447, 545 can accommodate burrs produced during injection molding of the lens elements 3, 4, 5 to improve assembly precision of the optical imaging lens.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical imaging lens comprising:
a lens barrel including a surrounding wall and a front wall connected to one end of said surrounding wall, said front wall having an abutting portion, and a first slanting surface portion connected to said abutting portion; and
an imaging lens unit disposed in said lens barrel and including a front lens element, a plurality of intermediate lens elements and a rear lens element arranged in an order from an object side to an image side, each of said front lens element, said intermediate lens elements and said rear lens element having an object side surface facing toward the object side and an image side surface facing toward the image side;
said front lens element having a first central lens portion and a first assembly portion surrounding said first central lens portion, said first assembly portion having a first front abutting section and a first front slanting surface section disposed at said object side surface of said front lens element, and a first rear slanting surface section disposed at said image side surface of said front lens element;
each of said intermediate lens elements having a second central lens portion and a second assembly portion surrounding said second central lens portion, said second assembly portion of each of said intermediate lens elements having a second front slanting surface section disposed at said object side surface thereof, and a second rear slanting surface section disposed at said image side surface thereof;
said rear lens element having a third central lens portion and a third assembly portion surrounding said third central lens portion, said third assembly portion having a third front slanting surface section disposed at said object side surface of said rear lens element;
wherein said first front abutting section and said first front slanting surface section of said first assembly portion abut against said abutting portion and said first slanting surface portion of said front wall respectively, such that said first assembly portion is coupled with said front wall;
wherein said second front slanting surface section of said second assembly portion of a frontmost one of said intermediate lens elements abuts against said first rear slanting surface section of said first assembly portion, such that said second assembly portion of the frontmost one of said intermediate lens elements is coupled with said front lens element;
wherein said second front slanting surface section of said second assembly portion of a rear one of said intermediate lens elements abuts against said second rear slanting surface section of said second assembly portion of one of said intermediate lens elements that is immediately in front of said rear one of said intermediate lens elements to thereby couple said second assembly portions of said intermediate lens elements to each other;
wherein said third front slanting surface section of said third assembly portion abuts against said second rear slanting surface section of said second assembly portion of a rearmost one of said intermediate lens elements that is immediately in front of said rear lens element, such that said second assembly portion of the rearmost one of said intermediate lens elements is coupled with said rear lens element.

2. The optical imaging lens as claimed in claim 1, wherein:
said first assembly portion further has a first rear abutting section disposed at said image side surface of said front lens element;
said second assembly portion of each of said intermediate lens elements further has a second front abutting section disposed at said object side surface thereof, and a second rear abutting section disposed at said image side surface thereof;
said third assembly portion further has a third front abutting section disposed at said object side surface of said rear lens element;
said first rear abutting section of said first assembly portion abuts against said second front abutting section of said second assembly portion of the frontmost one of said intermediate lens elements;
said second front abutting section of said second assembly portion of said rear one of said intermediate lens elements abuts against said second rear abutting section of said second assembly portion of said one of said intermediate lens elements that is immediately in front of said rear one of said intermediate lens elements; and
said third front abutting section of said third assembly portion abuts against said second rear abutting section of said second assembly portion of the rearmost one of said intermediate lens elements.

3. The optical imaging lens as claimed in claim 1, wherein said rear lens element has a peripheral surface that is coupled to an inner wall surface of said surrounding wall.

4. The optical imaging lens as claimed in claim 3, wherein said front lens element has a peripheral surface that is coupled to said inner wall surface of said surrounding wall.

5. The imaging lens as claimed in claim 1, wherein one of said intermediate lens elements has a peripheral surface that is coupled to an inner wall surface of said surrounding wall.

6. The optical imaging lens as claimed in claim 5, wherein said front lens element has a peripheral surface that is coupled to said inner wall surface of said surrounding wall.

7. The optical imaging lens as claimed in claim 1, further comprising a fixing unit, said fixing unit including a ring body disposed abuttingly between said image side surface of said rear lens element and an inner wall surface of said surrounding wall, and an adhesive connecting said ring body and said inner wall surface of said surrounding wall.

8. The optical imaging lens as claimed in claim 7, wherein said rear lens element further has a protruding portion disposed between said third central lens portion and a peripheral surface of said rear lens element at said image side surface of said rear lens element, said fixing unit being disposed at one side of said protruding portion that is radially opposite to an optical axis of said optical imaging lens.

9. The optical imaging lens as claimed in claim 7, wherein said adhesive is further connected to said image side surface of said rear lens element.

10. The optical imaging lens as claimed in claim 7, wherein said ring body has an annular indentation adjacent to said inner wall surface of said surrounding wall, said annular indentation and said inner wall surface of said surrounding wall cooperating to define an annular groove, said adhesive being filled in said annular groove and connecting said ring body and said inner wall surface of said surrounding wall.

11. The optical imaging lens as claimed in claim 1, wherein said first front slanting surface section has a maximum perpendicular distance to an optical axis of said optical imaging lens that is smaller than a maximum perpendicular distance of said first rear slanting surface section to the optical axis, and for each of said intermediate lens elements, said second front slanting surface section thereof has a maximum perpendicular distance to the optical axis that is smaller than a maximum perpendicular distance of said second rear slanting surface section thereof to the optical axis.

12. The optical imaging lens as claimed in claim 2, wherein:
said front wall further has a light blocking portion connected to said first slanting surface portion, said first slanting surface portion being disposed between said abutting portion and said light blocking portion, said light blocking portion being disposed closer to an optical axis of said optical imaging lens compared to said abutting portion;
each of said first front slanting surface section and said first rear slanting surface section is disposed between said first central lens portion and a respective one of said first front abutting section and said first rear abutting section;
for each of said intermediate lens elements, each of said second front slanting surface section and said second rear slanting surface section is disposed between said second central lens portion and a respective one of said second front abutting section and said second rear abutting section; and
said third front slanting surface section is disposed between said third front abutting section and said third central lens portion.

13. The optical imaging lens as claimed in claim 2, wherein:
said front wall further has a light blocking portion connected to said first slanting surface portion, said first slanting surface portion being disposed between said abutting portion and said light blocking portion, said light blocking portion being disposed closer to an optical axis of said optical imaging lens compared to said abutting portion;
each of said first front abutting section and said first rear abutting section is disposed between said first central lens portion and a respective one of said first front slanting surface section and said first rear slanting surface section;
for each of said intermediate lens elements, each of said second front abutting section and said second rear abutting section is disposed between said second central lens portion and a respective one of said second front slanting surface section and said second rear slanting surface section; and
said third front abutting section is disposed between said third central lens portion and said third front slanting surface section.

14. The optical imaging lens as claimed in claim 2, wherein each of said abutting portion, said first front abutting section, said first rear abutting section, said second front abutting section, said second rear abutting section, and said third front abutting section is an annular planar surface that is transverse to an optical axis of said optical imaging lens.

15. The optical imaging lens as claimed in claim 1, wherein:
said front wall of said lens barrel further has a second slanting surface portion radially spaced apart from said first slanting surface portion;
said first assembly portion further has a fourth front slanting surface section radially spaced apart from said first front slanting surface section and disposed at said object side surface of said front lens element, and a fourth rear slanting surface section radially spaced apart from said first rear slanting surface section and disposed at said image side surface of said front lens element;
said second assembly portion of each of said intermediate lens elements further has a fifth front slanting surface section radially spaced apart from said second front slanting surface section and disposed at said object side surface thereof, and a fifth rear slanting surface section radially spaced apart from said second rear slanting surface section and disposed at said image side surface thereof; and
said third assembly portion further has a sixth front slanting surface section radially spaced apart from said third front slanting surface section and disposed at said object side surface of said rear lens element.

16. The optical imaging lens as claimed in claim 1, wherein each of said front lens element, and said intermediate lens elements has a rear recess portion at said image side surface adjacent to a peripheral surface thereof, and a front recess portion at said object side surface adjacent to said peripheral surface thereof, and wherein said rear lens element has a front recess portion at said object side surface adjacent to a peripheral surface thereof.
